(19) United States
(12) Patent Application Publication
(10) Pub. No.: US 2025/0390098 A1
(43) Pub. Date: Dec. 25, 2025

(54) EFFICIENT VIEW SELECTION AND 3D SCENE RECONSTRUCTION FOR MOBILE ROBOTS WITH NEURAL RADIANCE FIELDS

(71) Applicant: Robert Bosch GmbH, Stuttgart (DE)

(72) Inventors: Michael Wang, Mountain View, CA (US); Marcus Gualtieri, Fremont, CA (US); Nan Tian, Foster City, CA (US); Christian Juette, Redwood City, CA (US); Ajay Tanwani, Fremont, CA (US); Liu Ren, Saratoga, CA (US)

(21) Appl. No.: 18/747,553

(22) Filed: Jun. 19, 2024

(51) Int. Cl. G05D 1/246; G05D 1/644; G05D 101/00; G05D 101/15; G05D 111/10

(52) U.S. Cl. CPC G05D 1/2464; G05D 1/644; G05D 2101/15; G05D 2101/22; G05D 2111/10

(57) ABSTRACT

A mobile robot system is described in having a mobile robot and cloud system. The mobile robot leverages cloud computing to offload Neural Radiance Fields (NeRF) based 3D scene reconstruction. The mobile robot advantageously adopts techniques for view filtering and next-best view selection that optimize the image collection process necessary for training an NeRF model with the cloud system. These techniques enable the mobile robot to discard redundant images that do not provide significant new information about the environment. Additionally, these techniques enable the mobile robot to strategically select next-best views that maximize the information gain, while minimizing a total number of images required and the time required to capture the images. These techniques provide a significant reduction in the overall bandwidth required for providing image data to the cloud system and can result in a more accurate and higher quality 3D reconstruction of the environment.

### FIELD

The devices and methods disclosed in this document relate to mobile robots and, more particularly, to efficient view selection and 3D scene reconstruction with neural radiance fields.

### BACKGROUND

Unless otherwise indicated herein, the materials described in this section are not admitted to be the prior art by inclusion in this section.

As demand for mobile robots continues to grow across various global industries, their need for efficient, reliable, and secure communication channels with other devices, such as fellow robots, computers, and cloud resources, becomes increasingly critical. Additionally, the limited computational capabilities of many mobile robots necessitate reliance on external resources for processing high-demand workloads.

Cloud robotics allows such mobile robots to leverage extensive computational power and storage beyond their physical confines over the network. However, the limitations imposed by network bandwidth in wirelessly communicating with cloud resources poses a challenge to its widescale adoption. These bandwidth and latency constraints are particularly pronounced when dealing with high-volume data like raw image streams, essential for visual robotic functionalities. Existing solutions involving image and video compression, for example, H264, offer some respite at the cost of additional computational overhead and occasional data loss.

Tasks such as 3D scene reconstruction with Neural Radiance Fields (NeRF) continue to be a challenge for mobile robots having limited computational capabilities. Neural Radiance Fields (NeRF) revolutionized 3D scene modeling and rendering through deep learning techniques. NeRF enables the synthesis of highly realistic 3D scenes from 2D images and are widely used for novel view synthesis and scene editing capabilities in virtual reality, augmented reality, and object tracking, among other computer vision domains. The core idea of NeRF is to learn a continuous 3D function that maps spatial coordinates to scene radiance values. By training the network to predict radiance values from 2D images with corresponding camera poses, NeRF enables synthesis of novel views for 3D reconstruction. However, NeRF is computationally demanding and has high bandwidth costs when performed in the cloud due to the need to transmit images to the cloud.

Adopting NeRF-based 3D scene reconstruction for mobile robots having limited computational capabilities necessitates access to cloud-based computational power. However, in such contexts, indiscriminate image data can overwhelm the available bandwidth, undermining the quality of the learned NeRF model. Consequently, intelligent selection of viewpoints that provide the most informative data for reconstructing and rendering scene quality remains a key challenge in NeRF based 3D reconstruction methods.

### SUMMARY

A method for operating a mobile robot is disclosed. The method comprises storing, in a memory of the mobile robot, 3D map data representing an environment. The method further comprises capturing, with a camera of the mobile robot, an image of the environment. The method further comprises determining, with a processor of the mobile robot, based on the 3D map data, whether the image is to be used to update the 3D map data. The method further comprises transmitting, with a transceiver of the mobile robot, the image to a remote server in response to determining that the image is to be used to update the 3D map data. The method further comprises receiving, with the transceiver, updates to the 3D map data from the remote server.

A further method for operating a mobile robot is disclosed. The method comprises storing, in a memory of the mobile robot, 3D map data representing an environment. The method further comprises determining, with a processor of the mobile robot, based on the 3D map data, a first view pose from which a first image is to be captured of the environment. The method further comprises operating the mobile robot to navigate to the first view pose and capturing, with a camera of the mobile robot, the first image of the environment from the first view pose. The method further comprises transmitting, with a transceiver of the mobile robot, the first image to the remote server. The method further comprises receiving, with the transceiver, updates to the 3D map data from the remote server.

### BRIEF DESCRIPTION OF THE DRAWINGS

The foregoing aspects and other features of the system and methods are explained in the following description, taken in connection with the accompanying drawings.

FIG. 1 summarizes components and operations of a mobile robot system.

FIG. 2A shows an exemplary embodiment of the mobile robot.

FIG. 2B shows an exemplary embodiment of the cloud system.

FIG. 3 shows a flow diagram for a method for operating a mobile robot to perform view filtering.

FIG. 4 shows a flow diagram for a method for operating a mobile robot to perform next-best view selection.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to one skilled in the art to which this disclosure pertains.

### Overview

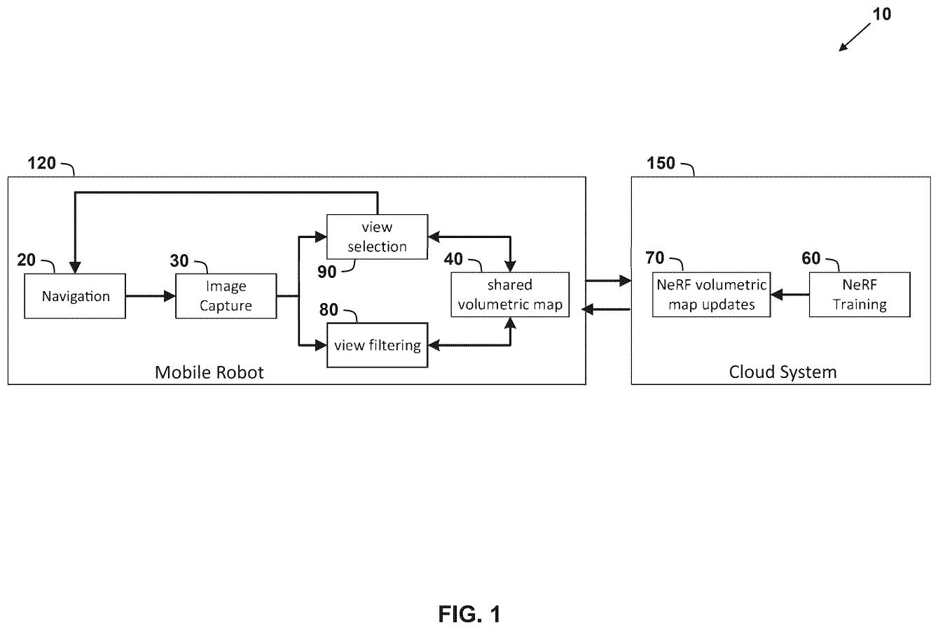

With reference to FIG. 1, components and operations of a mobile robot system 10 are summarized. The mobile robot system 10 includes at least one mobile robot 120 that performs a task in an environment. The mobile robot 120 advantageously leverages cloud computing to offload Neural Radiance Fields (NeRF) based 3D scene reconstruction. To these ends, the mobile robot system 10 further includes a cloud system 150. The cloud system 150 may comprise any computing device that is not physically located on the robot.

In general, the mobile robot 120 is configured to autonomously navigate an environment to perform a task. In some embodiments, the mobile robot 120 may comprise a cleaning robot, such as a robot vacuum or a robot mop, that is configured to navigate the environment to clean a floor surface in the environment. However, it should be appreciated by those of ordinary skill that the systems and methods described herein may be applicable to a wide variety of mobile robots that autonomously navigate an environment to perform a task.

As the mobile robot 120 navigates 20 the environment, the mobile robot 120 captures images 30 of the environment, as well as other sensor data, to detect positions of walls, objects, or other obstructions in the environment for the purpose of mapping, navigation, motion planning, and trajectory optimization tasks. To aid in navigation and performance of tasks in the environment, the mobile robot 120 advantageously leverages a shared volumetric map 40 of the environment. The shared volumetric map 40 is a voxel-based volumetric map representation of an NeRF scene reconstruction learned by the cloud system 150.

The shared volumetric map 40 is maintained and updated by the cloud system 150 based on sensor data, in particular images, received from mobile robot 120. To this end, the mobile robot 120 is configured to capture, and upload to the cloud system 150, images of the environment for the purpose of training 60 an NeRF model with the cloud system 150. The cloud system 150 receives the images from the mobile robot 120 and trains 60 the NeRF model. Based on this training 60, the cloud system 150 generates volumetric map updates 70, which are transmitted to the mobile robot 120. However, it should be appreciated that uploading a stream of images from the mobile robot 120 to the cloud system 150 requires significant bandwidth. Moreover, it should be appreciated that the NeRF can be effectively trained with a relatively small number of images of the environment if those images are captured from suitably diverse and information-rich view poses.

The mobile robot 120 advantageously minimizes the set of images that maximize the range of viewpoints required for efficient and accurate 3D reconstruction of the environment by employing techniques for view filtering 80 and view selection 90, thereby optimizing both bandwidth and NeRF reconstruction quality. Firstly, the mobile robot 120 intelligently filters 80 out images captured from redundant view poses from the images that are uploaded for 3D scene reconstruction, thereby significantly reducing the number of images transmitted over the network. Particularly, based on the view pose from which it was captured and based on the shared volumetric map 40, an information gain metric is calculated to quantify the amount of new information contained in the image for NeRF-based 3D reconstruction. Using this information gain metric, the mobile robot 120 determines whether the image should be uploaded to the cloud system 150 or discarded. Secondly, in some embodiments, the mobile robot 120 actively navigates the environment to seek out the next-best view poses and maximize coverage for efficient 3D scene reconstruction by the cloud system 150. Particularly, the mobile robot 120 automatically selects 90 a next-best view pose that is expected to maximize the information gain metric and then navigates 20 through the environment to capture 30 an image from the identified next-best view pose. In these ways, the mobile robot 120 advantageously optimizes transmission of images to the cloud system 150 for NeRF training, creating a balance between operational efficiency and computational resources.

### Mobile Robot

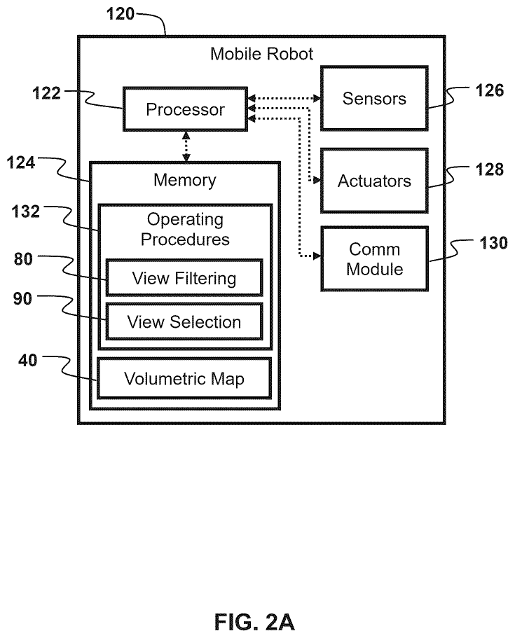

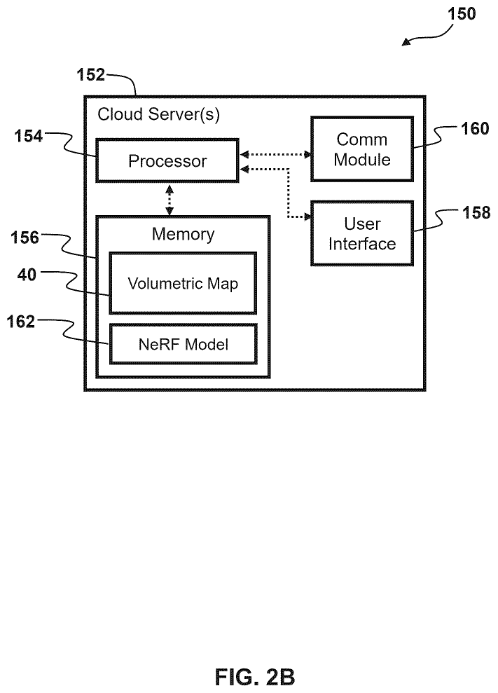

FIG. 2A shows an exemplary embodiment of the mobile robot 120. In the illustrated embodiment, the mobile robot 120 comprises, for example, a processor 122, a memory 124, one or more sensors 126, one or more actuators 128, and at least one network communications module 130. It will be appreciated that the illustrated embodiment of the mobile robot 120 is only one exemplary embodiment and is merely representative of any of various manners or configurations of mobile robots that autonomously navigate an environment to perform a task.

The processor 122 is configured to execute instructions to operate the mobile robot 120 to enable the features, functionality, characteristics and/or the like as described herein. To this end, the processor 122 is operably connected to the memory 124, the one or more sensors 126, and the one or more actuators 128. The processor 122 generally comprises one or more processors which may operate in parallel or otherwise in concert with one another. It will be recognized by those of ordinary skill in the art that a “processor” includes any hardware system, hardware mechanism or hardware component that processes data, signals or other information. Accordingly, the processor 122 may include a system with a central processing unit, graphics processing units, multiple processing units, dedicated circuitry for achieving functionality, programmable logic, or other processing systems.

The memory 124 is configured to store data and program instructions that, when executed by the processor 122, enable the mobile robot 120 to perform various operations described herein. The memory 124 may be any type of device capable of storing information accessible by the processor 122, such as a memory card, ROM, RAM, hard drives, discs, flash memory, or any of various other computer-readable media serving as data storage devices, as will be recognized by those of ordinary skill in the art. As discussed in further detail below, the processor 122 is configured to execute program instructions of an operating procedure 132, which is stored in the memory 124, to navigate the environment to perform a task. Additionally, the operating procedure 132 includes program instructions for view filtering 80 and view selection 90, as discussed in greater detail elsewhere herein. Aside from the operating procedures 132, the memory 124 also stores a local copy of the shared volumetric map 40.

The one or more sensors 126 may comprise a variety of different sensors. The sensors 126 at least include one or more cameras configured to capture a plurality of images of the environment as the mobile robot 120 navigates through the environment. The camera(s) generate image frames of the environment, each of which comprises a two-dimensional array of pixels. Each pixel has corresponding photometric information (color, intensity, and/or brightness). In some embodiments, the camera(s) are configured to generate RGB-D images in which each pixel has corresponding photometric information and geometric information (depth and/or distance). In such embodiments, the camera(s) may take the form of an RGB camera that operates in association with a LIDAR or IR sensor, in particular a LIDAR camera or IR camera, configured to provide both photometric information and geometric information. The LIDAR camera or IR camera may be separate from or directly integrated with the RGB camera. Alternatively, or in addition, the camera may comprise two RGB cameras configured to capture stereoscopic images, from which depth and/or distance information can be derived. Based on RGB-D images captured as the mobile robot 120 navigates the environment, the mobile robot 120 may implement visual and/or visual-inertial odometry methods such as simultaneous localization and mapping (SLAM) techniques.

Additionally, in at least some embodiments, the sensors 126 include a light sensor (e.g., LIDAR or any other time of flight or structured light-based sensor), configured to emit measurement light (e.g., lasers) and receive the measurement light after it has reflected throughout the environment. In time-of-flight based embodiments, the processor 122 is configured to determine distances to obstacles by calculating times of flight and/or return times for the measurement light. In structured light-based embodiments, the processor 122 applies an algorithm to extract a 3D profile of surfaces onto which the structured light is projected (e.g., based on a fringe pattern generated on a surface).

Finally, in some embodiments, the sensors 126 include sensors configured to measure one or more accelerations, rotational rates, and/or orientations of the mobile robot 120. In one embodiment, the sensors 126 include one or more accelerometers configured to measure linear accelerations of the mobile robot 120 along one or more axes (e.g., roll, pitch, and yaw axes), or one or more gyroscopes configured to measure rotational rates of the mobile robot 120 along one or more axes (e.g., roll, pitch, and yaw axes), and/or an inertial measurement unit configured to measure all of the above.

The one or more actuators 128 at least include motors of a locomotion system that, for example, drive a set of wheels to cause the mobile robot 120 to move throughout the environment to perform the task. Additionally, in some embodiments, the one or more actuators 128 include a vacuum suction system configured to vacuum a floor surface as the mobile robot 120 navigates through the environment. Mobile robots 120 that perform other tasks in the environment may, of course, include different types of actuators 128 that are suitable to other tasks.

The network communications module 130 may comprise one or more transceivers, modems, processors, memories, oscillators, antennas, or other hardware conventionally included in a communications module to enable communications with various other devices, at least including the cloud system 150 and/or the other mobile robots 120. Particularly, the network communications module 130 generally includes a Wi-Fi module configured to enable communication with a Wi-Fi network and/or Wi-Fi router (not shown). Additionally, the network communications module 130 may include a Bluetooth® module (not shown) configured to enable communication with a mobile device (not shown). Finally, the network communications module 130 may include one or more cellular modems configured to communicate with wireless telephony networks.

The mobile robot 120 may also include a respective battery or other power source (not shown) configured to power the various components within the mobile robot 120. In one embodiment, the battery of the mobile robot 120 is a rechargeable battery configured to be charged when the mobile robot 120 is connected to a base station that is configured for use with the mobile robot 120.

### Cloud System

As referenced above, the mobile robot 120 is in communication with a cloud system 150. Particularly, the cloud system 150 is configured to train a NeRF-based 3D reconstruction of the environment based on images received from the mobile robot 120 and to provide updates to the shared volumetric map 40.

FIG. 2B shows an exemplary embodiment of the cloud system 150. The cloud system 150 comprises one or more cloud servers 152. The cloud servers 152 may include servers configured to serve a variety of functions for the cloud system 150, including web servers or application servers depending on the features provided by the cloud system 150, but at least include one or more cloud servers 152 for training and maintaining a NeRF-based 3D reconstruction of the environment. Each cloud server 152 includes, for example, a processor 154, a memory 156, a user interface 158, and a network communications module 160. It will be appreciated that the illustrated embodiment of the cloud servers 152 is only one exemplary embodiment of a cloud server 152 and is merely representative of any of various manners or configurations of a personal computer, server, or any other data processing system that is operative in the manner set forth herein.

The processor 154 is configured to execute instructions to operate the cloud server 152 to enable the features, functionality, characteristics and/or the like as described herein. To this end, the processor 154 is operably connected to the memory 156, the user interface 158, and the network communications module 160. The processor 154 generally comprises one or more processors which may operate in parallel or otherwise in concert with one another. It will be recognized by those of ordinary skill in the art that a “processor” includes any hardware system, hardware mechanism or hardware component that processes data, signals or other information. Accordingly, the processor 154 may include a system with a central processing unit, graphics processing units, multiple processing units, dedicated circuitry for achieving functionality, programmable logic, or other processing systems.

The memory 156 is configured to store program instructions that, when executed by the processor 154, enable the cloud server 152 to perform various operations described herein. The memory 156 may be any type of device or combination of devices capable of storing information accessible by the processor 154, such as memory cards, ROM, RAM, hard drives, discs, flash memory, or any of various other computer-readable media recognized by those of ordinary skill in the art. As discussed in further detail below, the processor 154 is configured to execute program instructions stored in the memory 156, to receive images from the mobile robot, train a NeRF model 162 of the environment, and provide updates to the shared volumetric map 40.

The cloud server 152 may be operated locally or remotely by an administrator. To facilitate local operation, the cloud server 152 may include the user interface 158. In at least one embodiment, the user interface 158 may suitably include an LCD display screen or the like, a mouse or other pointing device, a keyboard or other keypad, speakers, and a microphone, as will be recognized by those of ordinary skill in the art. Alternatively, in some embodiments, an administrator may operate the cloud server 152 remotely from another computing device which is in communication therewith via the network communications module 160 and has an analogous user interface. The network communications module 160 provides an interface that allows for communication with any of various devices, at least including the mobile robots 120. In particular, the network communications module 160 may include a local area network port that allows for communication with any of various local computers housed in the same or nearby facility. Generally, the cloud server 152 communicates with remote computers over the Internet via a separate modem and/or router of the local area network. Alternatively, the network communications module 160 may further include a wide area network port that allows for communications over the Internet. In one embodiment, the network communications module 160 is equipped with a Wi-Fi transceiver or other wireless communications device. Accordingly, it will be appreciated that communications with the cloud server 152 may occur via wired communications or via the wireless communications. Communications may be accomplished using any of various known communications protocols.

### Methods for Operating a Mobile Robot System to Perform View Filtering

A variety of methods and processes are described below for operating a mobile robot system to perform view filtering. In these descriptions, statements that a method, processor, and/or system is performing a task or function refers to a controller or processor (e.g., the processor 122 of the mobile robot 120 or the processor 154 of the cloud server 152) executing programmed instructions stored in non-transitory computer readable storage media (e.g., the memory 124 of the mobile robot 120 or the memory 156 of the cloud server 152) operatively connected to the controller or processor to manipulate data or to operate one or more components in the mobile robot 120 or the cloud server 152 to perform the task or function. Additionally, the steps of the methods may be performed in any feasible chronological order, regardless of the order shown in the figures or the order in which the steps are described.

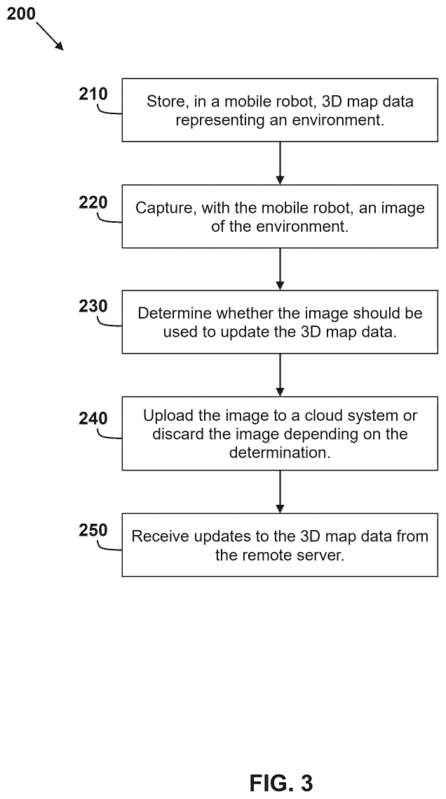

FIG. 3 shows a flow diagram for a method 200 for operating a mobile robot to perform view filtering. The method 200 advantageously enables the mobile robot 120 to discard images captured from redundant view poses that do not provide significant new information about the environment, e.g. images capturing the same viewpoint or containing irrelevant background information. This provides a significant reduction in the overall bandwidth required for providing image data to the cloud system 150 for training and maintaining a NeRF-based 3D reconstruction of the environment. Moreover, in at least some cases, the discarding of images captured from redundant view poses can result in a more accurate and higher quality NeRF-based 3D reconstruction of the environment by the cloud system 150.

The method 200 begins with storing, in a mobile robot, 3D map data representing an environment (block 210). Particularly, the memory 124 of the mobile robot 120 stores 3D map data representing an environment. In at least some embodiments, the 3D map data takes the form of a shared volumetric map 40 having a plurality of voxels. Each voxel has an occupancy score, which is a measure of the voxel's visibility information and quantifies how occupied a corresponding portion of the environment is with obstacles, such as objects, walls, floors, or other solid or liquid bodies.

The shared volumetric map 40 is generated by the cloud system 150 using a NeRF-based 3D reconstruction of the environment, in particular using a NeRF model 162. It will be appreciated by those of ordinary skill in the art, that a Neural Radiance Field (NeRF) is a neural network model that represents a 3D scene as a continuous function. The input to a NeRF includes a 3D location (x, y, z) and a 2D viewing direction (θ, ϕ). The output of a NeRF includes an emitted color or radiance values (r, g, b) and a volume density σ. In other words, given a particular viewing direction, the NeRF maps spatial coordinates to scene radiance values and to a volume density.

The cloud system 150 generates the shared volumetric map 40 based on the NeRF model 162. Particularly, based on images captured by the mobile robot 120 of its environment, the processor 154 of the cloud system 150 trains the NeRF model 162 to predict scene radiance values and volume densities of the environment. Through this training, the weights of the NeRF model 162 embody a 3D reconstruction of the environment of which the images were captured by the mobile robot 120. After training the NeRF model 162, the processor 154 generates the shared volumetric map 40 using the NeRF model 162. To this end, in one embodiment, the processor 154 integrates the volume density σ over the volume of each respective voxel to determine the respective occupancy score for each respective voxel. In this way, the shared volumetric map 40 can be understood as a coarse volumetric representation of the NeRF model 162, allowing it to be used efficiently for real-time view filtering and view selection with reduced computational resources on the mobile robot 120.

The method 200 continues with capturing, with the mobile robot, an image of the environment (block 220). Particularly, the processor 122 of the mobile robot 120 operates a camera of the sensors 126 to capture an image of the environment. As discussed above, the images from the camera may take the form of RGB images, RGB-D images, stereoscopic pairs of RGB images, and the like. Additionally, the processor 122 of the mobile robot 120 operates the sensors 126 to capture a wide variety of additional sensor data. In some embodiments, based on the image and/or additional sensor data captured by the sensors 126, the processor 122 determines a view pose (camera pose) from which the image was captured, for example using visual and/or visual-inertial odometry methods such as simultaneous localization and mapping (SLAM) techniques. The view pose takes the form of a 3D spatial position and a viewing direction, e.g., within the coordinate system of the shared volumetric map 40.

The method 200 continues with determining whether the image should be used to update the 3D map data (block 230). Particularly, the processor 122 of the mobile robot 120 determines, based on the shared volumetric map 40, whether the image is to be used to update the shared volumetric map 40. To this end, the processor 122 determines an information gain metric based on the shared volumetric map 40, based on the view pose from which the image was captured and/or based on the image itself. The information gain metric quantifies an amount of new information about the environment that is in the image. The processor 122 determines whether the image is to be used to update the shared volumetric map 40 based on the information gain metric, for example by comparison with a threshold value for the information gain metric.

In some embodiments, the processor 122 determines a value of the information gain metric for the image by summing over the occupancy score of each voxel within the field of view of the camera of the mobile robot 120 at the view pose from which the image was captured. Particularly, the processor 122 identifies a subset of voxels from the plurality of voxels that are within a field of view of the image, e.g., by casting rays through the voxels from the view pose. The processor 122 determines the information gain metric for the image based on the respective occupancy scores of the subset of voxels, for example by summing the respective occupancy scores of the subset of voxels, thereby quantifying the visibility information from the view pose. It should be appreciated that this method of determining the information gain metric can be performed solely on the basis of the shared volumetric map 40 and the view pose from which the image was captured and does not require processing the image itself.

In another embodiment, the processor 122 determines a value of the information gain metric for the image using a neural network that is trained to output a value for the information gain metric based on one or more of the shared volumetric map 40, the view pose from which the image was captured, and/or the image itself. In one example, the processor 122 determines a semantic representation (e.g., a text description, a text classification) of the image using a neural network, such as a contrastive language-image pre-training (CLIP) model. The processor 122 determines the information gain metric based on the semantic representation of the image, for example by comparing the semantic representation with a semantic representation of previously captured images. In this way, the processor 122 detects how different images relate to each other based on their content and analyzes each image to ascertain how useful it will be in understanding the overall scene, while advantageously discarding changes in lighting conditions and sensory irregularities.

Regardless of how the information gain metric is determined, the processor 122 determines whether the image is to be used to update the shared volumetric map 40 based on the information gain metric. Particularly, in one embodiment, the processor 122 compares the information gain metric with a threshold value corresponding to a threshold amount of new information about the environment in the image. The processor 122 determines whether the image is to be used to update the shared volumetric map 40 based on the comparison. The processor 122 determines that the image is to be used to update the shared volumetric map 40 in response to the information gain metric exceeding a threshold value for the information gain metric. Conversely, the processor 122 determines that the image should be discarded in response to the information gain metric being less than the threshold value.

It should be appreciated that, rather than the information gain metric discussed above, the processor 122 can conversely determine an information redundancy metric that quantifies an amount of redundant information about the environment that is in the image (i.e., a metric in which a relatively smaller value corresponds to a relatively larger amount of new information about the environment in the image). In such embodiments, the processor 122 determines that the image is to be used to update the shared volumetric map 40 in response to the information redundancy metric being less than a threshold value for the information redundancy metric. Conversely, the processor 122 determines that the image should be discarded in response to the information redundancy metric exceeding the threshold value.

The method 200 continues with uploading the image to a remote server or discarding the image depending on the determination (block 240). Particularly, in response to determining that the image is to be used to update the shared volumetric map 40, the processor 122 operates the network communications module 130 to transmit the image to the cloud system 150. In at least one embodiment, the processor 122 compresses the image prior to transmitting the image to the cloud system 150. In at least some embodiments, the processor 122 operates the network communications module 130 to also transmit other sensor data captured at the time the image was captured, such as inertial and/or acceleration data, and other related information, such as the view pose from which the image was captured. The processor 154 of the cloud server 152 operates the network communications module 160 to receive the image, as well as the other sensor data and other related information.

Conversely, in response to determining that the image is not to be used to update the shared volumetric map 40, the processor 122 discards the image, which may include deleting the image from the memory 124 or simply not uploading it to the cloud system 150 for the purpose of updating the shared volumetric map 40.

The method 200 continues with receiving updates to the 3D map data from the remote server (block 250). Particularly, the processor 154 of the cloud server 152 updates the NeRF model 162 using the received image. Based on the updated NeRF model 162, the processor 154 generates updates to the shared volumetric map 40. Next, the processor 154 operates the network communications module 160 to transmit updates to the shared volumetric map 40 to the mobile robot 120. Finally, the processor 122 operates the network communications module 130 to receive updates to the shared volumetric map 40 and accordingly updates the shared volumetric map 40 that is stored in the memory 124.

### Methods for Operating a Mobile Robot to Perform Next-Best View Selection

A variety of methods and processes are described below for operating a mobile robot system to perform next-best view selection. In these descriptions, statements that a method, processor, and/or system is performing a task or function refers to a controller or processor (e.g., the processor 122 of the mobile robot 120 or the processor 154 of the cloud server 152) executing programmed instructions stored in non-transitory computer readable storage media (e.g., the memory 124 of the mobile robot 120 or the memory 156 of the cloud server 152) operatively connected to the controller or processor to manipulate data or to operate one or more components in the mobile robot 120 or the cloud server 152 to perform the task or function. Additionally, the steps of the methods may be performed in any feasible chronological order, regardless of the order shown in the figures or the order in which the steps are described.

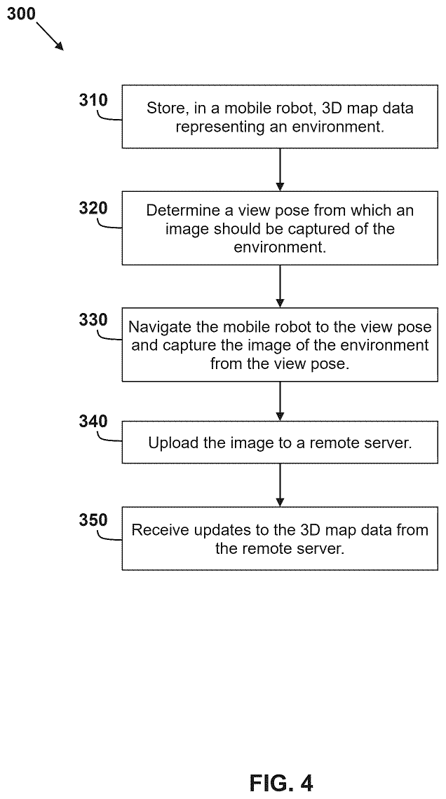

FIG. 4 shows a flow diagram for a method 300 for operating a mobile robot to perform next-best view selection. It should be appreciated that view planning is the problem of covering the 3D environment with the least number of image viewpoints. Manual view planning, for example, using a circular trajectory along the object of interest is often inefficient and inaccurate in capturing granular object details. Instead, the method 300 optimizes the view planning problem by intelligently selecting the next-best view by maximizing the information gain metric, weighted by a cost associated with moving the mobile robot 120 to the next-best view pose in the environment. Thus, the method 300 maximizes the likelihood of seeing new parts of the objects in the environment, while minimizing the amount of images and the time required to capture the images. As with the method 200, the method 300 also provides a significant reduction in the overall bandwidth required for providing image data to the cloud system 150 for the purpose of training and maintaining a NeRF-based 3D reconstruction of the environment and, likewise can result in a more accurate and higher quality NeRF-based 3D reconstruction of the environment by the cloud system 150.

The method 300 begins with storing, in a mobile robot, 3D map data representing an environment (block 310). Particularly, the memory 124 of the mobile robot 120 stores 3D map data representing an environment. In at least some embodiments, the 3D map data takes the form of a shared volumetric map 40 having a plurality of voxels. As noted before, each voxel has an occupancy score, which is a measure of the voxel's visibility information and quantifies how occupied a corresponding portion of the environment is with obstacles, such as objects, walls, floors, or other solid or liquid bodies.

The method 300 continues with determining a view pose from which an image should be captured of the environment (block 320). Particularly, based on the shared volumetric map 40, the processor 122 determines a next-best view pose from which a next image is to be captured of the environment by the camera of the mobile robot 120. In at least some embodiments, the processor 122 determines a plurality of candidate view poses. Each candidate view pose takes the form of a 3D spatial position and a viewing direction, e.g., within the coordinate system of the shared volumetric map 40. Next, the processor 122 evaluates the plurality of candidate view poses by determining a respective information gain metric for each candidate view pose. Finally, the processor 122 selects the next-best view pose from the plurality of candidate view poses based at least in part on the respective information gain metric for each candidate view pose.

In some embodiments, the processor 122 determines the plurality of candidate view poses by sampling a defined view pose space within the environment and/or within the shared volumetric map 40. Particularly, in one embodiment, the processor 122 defines a sphere centered about the mobile robot 120 or a particular object of interest in the environment. Next, the processor 120 randomly or uniformly samples candidate view poses that have a spatial position located on a surface of the defined sphere. However, in some embodiments, the processor 122 determines the plurality of candidate view poses simply by randomly or uniformly sampling candidate view poses within a predefined volume of space of within the environment and/or within the shared volumetric map 40 and within a predefined range of acceptable viewing directions. In some embodiments, the defined view pose space that is sampled may be constrained in a manner that avoids sampling candidate view poses that are not possible for a particular mobile robot. For example, if the mobile robot 120 can only navigate on the ground, then the defined view pose space maybe be limited to only a certain range of heights from the ground.

Next, the processor 120 determines a respective information gain metric for each candidate view pose based on the shared volumetric map 40 and based on the view pose from which the image was captured. As similarly discussed above, the respective information gain metric quantifies an amount of new information about the environment expected to be in an image captured of the environment from the respective candidate view pose.

In some embodiments, the processor 122 determines a value of the respective information gain metric for the respective candidate view pose by summing over the occupancy score of each voxel that would be within the field of view of the camera of the mobile robot 120 at the respective candidate view pose. Particularly, the processor 122 identifies a subset of voxels from the plurality of voxels that are within a field of view of the respective candidate view pose, e.g., by casting rays through the voxels from the respective candidate view pose. The processor 122 determines the respective information gain metric for the respective candidate view pose based on the respective occupancy scores of the subset of voxels, for example by summing the respective occupancy scores of the subset of voxels, thereby quantifying the expected visibility information from the respective candidate view pose.

In another embodiment, the processor 122 determines a value of the respective information gain metric for the image using a neural network that is trained to output a value for the information gain metric based on one or more of the shared volumetric map 40 and/or the respective candidate view pose.

Once the respective information gain metric is determined for each candidate view pose, the processor 122 selects the next-best view pose from the plurality of candidate view poses based on the respective information gain metrics. In one embodiment, the processor 122 selects the respective candidate view pose having the highest respective information gain metric.

In some embodiments, the processor 122 determines a respective weighted information gain metric for each candidate view pose by weighting the respective information gain metric based on a time required to navigate the mobile robot 120 to the respective candidate view pose from a current view pose of the mobile robot 120. The processor 122 selects the next-best view pose from the plurality of candidate view poses based on the respective weighted information gain metrics. Particularly, in one embodiment, the processor 122 selects the next-best view pose as the respective candidate view pose having a highest weighted information gain metric.

It should be appreciated that, rather than the information gain metric discussed above, the processor 122 can conversely determine an information redundancy metric that quantifies an amount of redundant information about the environment that is in the image (i.e., a metric in which a relatively smaller value corresponds to a relatively larger amount of new information about the environment in the image). In such embodiments, the processor 122 selects the next-best view pose as the respective candidate view pose having a smallest information redundancy metric and/or weighted information redundancy metric.

In some embodiments, the processor 122 selects the next-best view pose based on the shared volumetric map 40 using a neural network. The neural network is trained to receive the shared volumetric map 40 and a current position and/or current view pose of the mobile robot 120 and to output a next-best view pose. In one embodiment, such a neural network is trained using reinforcement learning, where it is rewarded for maximizing an amount of new information about the environment expected to be in an image captured of the environment from the next-best view pose, while minimizing a time required to navigate the mobile robot 120 to the next-best view pose from the current position and/or current view pose of the mobile robot 120.

The method 300 continues with navigating the mobile robot to the view pose and capturing the image of the environment from the view pose (block 330). Particularly, the processor 122 operates actuators 124 to cause the mobile robot 120 to navigate to a position corresponding to the next-best view pose and to position the camera of the mobile robot 120 to have the viewing direction corresponding to the next-best view pose. Once the mobile robot 120 has arrived at the next-best view pose, the processor 122 of the mobile robot 120 operates the camera to capture an image of the environment. As discussed above, the images from the camera may take the form of RGB images, RGB-D images, stereoscopic pairs of RGB images, and the like. Additionally, the processor 122 of the mobile robot 120 operates the sensors 126 to capture a wide variety of additional sensor data.

The method 300 continues with uploading the image to a remote server (block 340). Particularly, the processor 122 operates the network communications module 130 to transmit the image to the cloud system 150. In at least one embodiment, the processor 122 compresses the image prior to transmitting the image to the cloud system 150. In at least some embodiments, the processor 122 operates the network communications module 130 to also transmit other sensor data captured at the time the image was captured, such as inertial and/or acceleration data, and other related information, such as the view pose from which the image was captured. The processor 154 of the cloud server 152 operates the network communications module 160 to receive the image, as well as the other sensor data and other related information.

The method 300 continues with receiving updates to the 3D map data from the remote server (block 350). Particularly, the processor 154 of the cloud server 152 updates the NeRF model 162 using the received image. Based on the updated NeRF model 162, the processor 154 generates updates to the shared volumetric map 40. Next, the processor 154 operates the network communications module 160 to transmit updates to the shared volumetric map 40 to the mobile robot 120. Finally, the processor 122 operates the network communications module 130 to receive updates to the shared volumetric map 40 and accordingly updates the shared volumetric map 40 that is stored in the memory 124.

Embodiments within the scope of the disclosure may also include non-transitory computer-readable storage media or machine-readable medium for carrying or having computer-executable instructions (also referred to as program instructions) or data structures stored thereon. Such non-transitory computer-readable storage media or machine-readable medium may be any available media that can be accessed by a general purpose or special purpose computer. By way of example, and not limitation, such non-transitory computer-readable storage media or machine-readable medium can comprise RAM, ROM, EEPROM, CD-ROM or other optical disk storage, magnetic disk storage or other magnetic storage devices, or any other medium which can be used to carry or store desired program code means in the form of computer-executable instructions or data structures. Combinations of the above should also be included within the scope of the non-transitory computer-readable storage media or machine-readable medium.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A method for operating a mobile robot, the method comprising:
storing, in a memory of the mobile robot, 3D map data representing an environment;
capturing, with a camera of the mobile robot, an image of the environment;
determining, with a processor of the mobile robot, based on the 3D map data, whether the image is to be used to update the 3D map data;
transmitting, with a transceiver of the mobile robot, the image to a remote server in response to determining that the image is to be used to update the 3D map data; and
receiving, with the transceiver, updates to the 3D map data from the remote server.

2. The method according to claim 1, the determining whether the image is to be used to update the 3D map data further comprising:
determining, based on the 3D map data, a metric that quantifies an amount of new information about the environment that is in the image; and
determining that the image is to be used to update the 3D map based on a comparison of the metric with a threshold value.

3. The method according to claim 2, wherein the 3D map data includes a plurality of voxels, each voxel having an occupancy score that quantifies how occupied a corresponding portion of the environment is by obstacles, the determining the metric further comprising:
identifying a subset of voxels from the plurality of voxels that are within a field of view of the image; and
the determining the metric based on the occupancy scores of the subset of voxels.

4. The method according to claim 3, the determining the metric further comprising:
determining the metric as a sum of the occupancy scores of the subset of voxels.

5. The method according to claim 3, wherein the occupancy score of each voxel in the plurality of voxels is determined by the remote server using a neural radiance field representation of the environment.

6. The method according to claim 2, the determining the metric further comprising:
determining a semantic representation of the image using a neural network model; and
determining the metric based on the semantic representation.

7. The method according to claim 6, wherein the neural network model is a contrastive language-image pre-training model.

8. The method according to claim 2, the determining whether the image is to be used to update the 3D map data further comprising:
determining that the image is to be used to update the 3D map in response to the metric exceeding a threshold value.

9. The method according to claim 1 further comprising:
compressing, with the processor, the image prior to transmitting the image to the remote server.

10. A method for operating a mobile robot, the method comprising:
storing, in a memory of the mobile robot, 3D map data representing an environment;
determining, with a processor of the mobile robot, based on the 3D map data, a first view pose from which a first image is to be captured of the environment;
operating the mobile robot to navigate to the first view pose and capturing, with a camera of the mobile robot, the first image of the environment from the first view pose;
transmitting, with a transceiver of the mobile robot, the first image to the remote server; and
receiving, with the transceiver, updates to the 3D map data from the remote server.

11. The method according to claim 10, the determining the first view pose further comprising:
determining a plurality of candidate view poses;
determining, based on the 3D map data, a respective metric for each respective candidate view pose of the plurality of candidate view poses, the respective metric quantifying an amount of new information about the environment expected to be in a respective image captured of the environment from the respective candidate view pose; and
selecting the first view pose from the plurality of candidate view poses based on the respective metric for each respective candidate view pose of the plurality of candidate view poses.

12. The method according to claim 11, the determining the plurality of candidate view poses further comprising:
defining a sphere centered about the mobile robot or an object in the environment; and
sampling the plurality of candidate view poses across a surface of the sphere.

13. The method according to claim 10, wherein the 3D map data includes a plurality of voxels, each voxel having an occupancy score, the determining the respective metric for each respective candidate view pose of the plurality of candidate view poses further comprising:
identifying a subset of voxels from the plurality of voxels that are within a field of view of the respective view pose; and
the determining the respective metric based on the occupancy scores of the subset of voxels.

14. The method according to claim 13, the determining the respective metric for each respective candidate view pose of the plurality of candidate view poses further comprising:
determining the respective metric as a sum of the occupancy scores of the subset of voxels.

15. The method according to claim 13, wherein the occupancy score of each voxel in the plurality of voxels is determined using a neural radiance field representation of the environment.

16. The method according to claim 11, the selecting the first view pose further comprising:
selecting the first view pose as the respective candidate view pose of the plurality of candidate view poses having a highest respective metric.

17. The method according to claim 11, the selecting the first view pose further comprising:
determining, for each respective candidate view pose of the plurality of candidate view poses, a respective weighted metric by weighting the respective metric based on a time required to navigate the mobile robot to the respective candidate view pose from a current view pose of the mobile robot.

18. The method according to claim 10, the determining the first view pose further comprising:
determining the first view pose based on the 3D map data using a neural network.

19. The method according to claim 18, wherein the neural network is trained to maximize an amount of new information about the environment expected to be in a respective image captured of the environment from the first view pose, while minimizing a time required to navigate the mobile robot to the first view pose from a current view pose of the mobile robot.

20. The method according to claim 10 further comprising:
compressing, with the processor, the image prior to transmitting the image to the remote server.
